(19) United States
(12) Patent Application Publication
(10) Pub. No.: US 2026/0320086 A1
(43) Pub. Date: Oct. 15, 2026

(54) COMPUTER-IMPLEMENTED METHOD AND COMPUTER PROGRAM PRODUCT

(71) Applicant: TAXY.IO GMBH, Aachen (DE)

(72) Inventors: Daniel Hubert Friedrich KIRCH, Köln (DE); Steffen KIRCHHOFF, Köln (DE); Sven PEPER, Aachen (DE)

(21) Appl. No.: 19/104,541

(22) PCT Filed: Aug. 22, 2022
(86) PCT No.: PCT/EP2022/073303

§ 371 Date: Feb. 18, 2025

(51) Int. Cl. G06F 16/3329; G06F 16/338; G06V 30/416

(52) U.S. Cl. CPC G06F 16/33295; G06F 16/338; G06V 30/416

(57) ABSTRACT

A computer-implemented method for determining relevant answer passages from an answer corpus for a question relating to a legal matter includes using a ranking function to assess a relevance of the answer passages to the query and determine a list of relevant answer passages from the answer passages of the answer corpus. The relevant answer passages are a fixed number of the answer passages of the answer corpus that are the best possible candidates for answering the query. The relevant answer passages in the list are then sorted in descending relevance using a machine learning semantic language model, with the query and the relevant answer passages being vectorized only during the step of sorting after the relevant passages are determined by the ranking function. The list of relevant answer passages is then output in descending relevance.

The invention relates to a computer-implemented method and a computer program product for determining relevant answer passages from an answer corpus concerning a query relating to a legal matter.

One of the greatest challenges of legal consultancy, in particular also in tax consultancy, is the sheer flood of information that a consultant is exposed to. Mention should be made, on the one hand, of the regulatory information, that is to say laws, judgements, decrees, comments, etc., on the basis of which legal or tax consultancy is provided for clients, and, on the other hand, of the data that characterize a client—from master data through payment flows to communication data.

In order for a legal consultant, in particular a lawyer or tax consultant, to be able to advise their client, they must first understand and internalize the respective legal field. The method according to the invention relates to the automated processing of literature having legal (tax) relevance, such as the analysis of legal (tax) documents, in particular laws and judgements, how they correlate and what weightings (rankings) they have among themselves, the identification of issues in judgements, laws, sections of expert opinions and other legal documents, and the identification of important entities in a text, such as acting legal or natural persons, important places, professions, data, values, and the identification of references in legal texts.

The computer-implemented method uses an answer corpus of possible answer passages concerning queries that relate to a legal matter. The answer corpus comprises a collection of digital legal documents, e.g. laws, judgements, comments and proprietary documents of the user of the method.

The query concerning the legal matter, i.e. the trigger for determination of the relevant answer passages, is usually a passage of text containing a legal (tax) matter as a description of the facts in a document created using a word processor or an e-mail containing a client query. The possible answers come from the answer corpus.

The prior art already reveals approaches for determining relevant answer passages concerning legal questions:

“Legal question answering by deep learning”, Lu Liu and Jing Luo, Lecture Notes in Computer Science Lect. Notes Computer, 20180706 Springer, Berlin, Heidelberg, vol. 10956 Chap. 19, no. 558, 173-181 reveals a method for answering legal questions that comprises word segmentation and keyword selection, followed by a deep learning algorithm to answer the legal question.

Legal Question Answering using Ranking SVM and Deep Convolutional Neural Network, Phong-Khac Do and Huy-Tien Nguyen and Chien-Xuan Tran and Minh-Tien Nguyen and Minh-Le Nguyen, (https://doi.org/10.48550/arXiv.1703.05320-retrieved on 08.08.2022) discloses a method for answering legal questions. First, relevant legal information is determined by ranking legal articles. A neural network is then used to answer the question on the basis of the best-rated articles.

Applying a Convolutional Neural Network to Legal Question Answering, Mi-Young Kim, Ying Xu, Randy Goebel, Otake M., Kurahashi S., in: Ota Y., Satoh K., Bekki D. (eds) New Frontiers in Artificial Intelligence. JSAI-isAI 2015. Lecture Notes in Computer Science, vol 10091. Springer, Cham., 282-294, discloses a method for finding answers to legal questions. In a first phase, legal articles are sorted by relevance, and in a second phase, the question is answered by comparing the relevant articles with the extracted meanings of the query.

US 2019/0188262 A1 describes systems and methods for answering questions in natural language using neural networks. The answers are sorted by order of relevance to the query.

CN 110688452 A discloses a method and a system for rating the semantic similarity of texts, e.g. legal texts, comprising defining the training data as input for the neural network, training the semantic text similarity model and inputting a query into the semantic vector model in order to obtain a text search result.

Based on this prior art, the object of the invention is that of providing a computer-implemented method and a computer program product of the type mentioned at the outset that, despite the use of a semantic language model that embeds text passages in high-dimensional vector spaces in a context-sensitive manner, can determine relevant answer passages using relatively few hardware resources and at high speed, an answer corpus that is required for application of the method and contains a high number of answer passages being simultaneously able to be provided or updated in a short time.

This object is achieved by a computer-implemented method having the features of claim 1 and a computer program product having the features of claim 7. Advantageous configurations of the invention result from the features of the dependent claims.

In order to reduce the number of possible candidates for the answer passages and thus the required computing power, a ranking function is applied in a first step in order to assess the relevance of the answer passages to the query and to determine a list containing a fixed number of possible candidates for the answer passages. The fixed number is a subset of the total number of possible answer passages, for example the best 10 000 candidates. The fixed number can be set by a fixed percentage, for example of 5, 10 or 25%, of the possible answer passages.

In particular, the OKAPI BM 25 function is used to determine the relevance. When searching for information, Okapi BM25 (BM is an abbreviation for best matching) is a ranking function used by search engines to judge the relevance of documents to a particular search query. Okapi BM 25 is a bag-of-words retrieval function that classifies a series of documents on the basis of the search terms found in each document, regardless of their proximity within the document.

Despite the use of a semantic language model that embeds text passages in high-dimensional vector spaces in a context-sensitive manner, the method according to the invention can be operated using relatively low computing power and relatively few hardware resources, because the answer passages are vectorized only in the sorting step 1.3 on-the-fly, i.e. in real time, and if the fixed number of possible candidates for the answer passages has already been significantly reduced using the ranking function. The on-the-fly vectorization provided for according to the invention has multiple advantages:
1. All answer passages in the answer corpus are indexed in a vector-free manner. This significantly reduces the hardware resources required, because storing the high-dimensional vectors in the index would consume a large amount of storage space.
2. In addition, the time required for indexing the answer corpus is significantly reduced, because no computation-intensive vectorization operations have to be performed on answer passages during indexing. By providing answer passages indexed in a vector-free manner, an answer corpus that is required for application of the method and contains a high number of partial documents containing answer passages, e.g. several million, can therefore be provided using relatively low computing power in a short time.
3. Finally, model improvement cycles can be implemented much faster, because model improvements can be installed flexibly in an extremely short time and thus rendered accessible to the user, since no vectors have to be calculated. An A/B test is also easily possible, in which the current model is still used in 80% of the queries, for example, and a new, improved model is initially tested and evaluated for 20% of the queries. If the vectors of all indexed answer passages were to be stored in the index of the answer corpus in advance, new models would require each answer passage to be updated in the index. This process can take several weeks or months in practise, especially if the system is installed not in the cloud but rather in computer centers with the user and is operated with realistic index sizes of several hundred million partial documents.

After the best candidates within the list determined using the ranking function in the first step have been sorted using the at least one machine learning semantic language model, the best candidates are output in the form of a list with descending relevance of the answer passages. Depending on the query and the available answer corpus, the list may contain only one answer passage, in extreme cases no answer passages.

To provide the answer corpus, legal documents are broken down into partial documents containing one answer passage each, and the answer passages are indexed in a vector-free manner.

The legal documents include e.g. primary literature, e.g. laws and judgements, secondary literature, e.g. comments from publishers, and tertiary literature, e.g. registry documents (expert opinions, e-mails) of the user.

The legal documents of the primary and secondary literature come from external databases. The legal documents of the tertiary literature come in particular from software systems of the user of the method.

The at least one machine learning semantic language model is a language model that embeds text passages in high-dimensional vector spaces in a context-sensitive manner in order to determine semantic similarities in legal texts to be compared and/or semantic similarities of queries and answers from the answer corpus.

In particular the context-sensitive embedding of entire text passages in high-dimensional vector spaces improves the answer quality of the method compared to methods in which only single words are embedded, specifically always on the same vector regardless of context.

One semantic language model is BERT, for example. The acronym BERT stands for Bidirectional Encoder Representations from Transformers. This is a technique of machine learning and pre-training of transformer-based natural language processing models (NLP models) that was developed by Google and presented in 2018. Language models trained using BERT better capture the contextual correlations and relationships of the words. BERT works bidirectionally and uses artificial neural networks. At its core, BERT is based on transformer language models with a certain number of encoder and decoder layers and self-attention mechanisms. The deep neural networks (DNNs) used for BERT models consist of many neural layers and can map complex correlations.

For sentence pair regression tasks such as semantic text similarity (STS), it is necessary for both sentences or text passages to be fed into the network, resulting in massive computational complexity that requires about 50 million inference calculations (~65 hours) using BERT to find the most similar pair in a collection of 10 000 sentences.

The invention therefore preferably uses Sentence-BERT (SBERT), a modification of the pre-trained BERT language model, which uses Siamese and triplet network structures to derive semantically meaningful sentence embeddings that can be compared using cosine similarity. This reduces the effort for looking for the most similar pair from 65 hours using BERT to approximately 5 seconds using SBERT, the accuracy of BERT being maintained.

The training data used for the pre-training are general texts and also specialist legal texts, in order to train the system in a general understanding of the language taking into account the specialist legal language. The general texts used for a system trained in German were Wikipedia texts (www.wikipedia.de) containing more than one billion data sets. The specialist legal texts used were Federal German laws (www.gesetze-im-internet.de), judgements, primary legal literature (www.rechtsprechung-im-internet.de), European laws and judgements (https.://eur-lex.europa.eu) and Austrian laws and judgements (https://www.ris.bka.gv.at), a total of around 2 million data sets. The pre-training step is based on supervised learning.

Following the pre-training, a fine-tuning step for the specific task in the legal area takes place with a smaller amount of data sets, e.g. about 500 000 data sets. The training data used are in particular data sets containing question-answer pairs concerning legal matters and also queries concerning a legal matter and the answer passages with user ratings that are output from the data sets concerning the queries. User ratings are training data that are added to the running system as training data. The fine-tuning step is performed by means of supervised learning using the questions and answers of the question-answer pairs.

The table below shows the training data for the pre-training in rows 1 and 2 and the training data for the fine-tuning step in row 3:

Table of training data:

| | | Number of | |
|---|---|---|---|
| No. | Type | data sets | Remark |
| 1 | General texts from | >1 billion | www.wikipedia.de, |
| | German such as | | etc. |
| | German Wikipedia | | |
| | and other news | | |
| | pages | | |
| 2 | Specialist legal | approximately | www.gesetze-im- |
| | texts such as | 2 million | internet.de |
| | Federal German | | |
| | laws, judgements, | | |
| | primary legal | | www.rechtsprechung- |
| | literature | | im-internet.de |
| | European laws, | | https://eur- |
| | judgements | | lex.europa.eu/ |
| | Austrian laws and | | https://www.ris.bka.gv.at/ |
| | judgements | | |

| | | Number | |
|---|---|---|---|
| No. | Type | Data sets | Remark |
| 3 | Question-answer | approximately | |
| | corpus | 500 thousand | |
| | Question-answer | | Created by the |
| | pairs (DE) | | provider of the |
| | | | method or obtained |
| | | | through third |
| | | | parties, e.g. |
| | | | Deubner: Ask a lawyer |
| | User feedback on | | Users rate suggested |
| | suggested answers | | answers, e.g. by |
| | (DE, AT) | | clicking on thumbs |
| | | | up/thumbs down. |

In addition to BERT, transformer-based language models that can be considered are GPT-2/GPT-3:

Generative Pre-trained Transformer 2 (GPT-2) is a model that, inter alia, can answer questions and summarize passages. The model has not been specifically trained for these tasks, and its ability to perform them is an extension of its general ability to accurately synthesize the next item in any order. The GPT architecture implements a deep neural network, in particular a transformer model is used. Attention mechanisms allow the model to selectively focus on segments of the input text that it predicts to be the most relevant.

Generative Pre-trained Transformer 3 (GPT-3) is the third-generation language prediction model in the GPT-n series and the successor to GPT-2.

Another suitable language model for the context-sensitive embedding of entire passages in high-dimensional vector spaces is Universal Sentence Encoder (USE) from Google. The high-dimensional vectors can be used, inter alia, for text classification and for determining semantic similarities in natural language.

The computer-implemented method is carried out in particular by a computer program product that, when the program is executed by a computer, cause said computer to carry out the steps of the computer-implemented method that are described above.

In order to ensure a system break in the user experience and thus an efficient process, the program for carrying out the computer-implemented method can be integrated into different office applications, e.g. Microsoft Word, Microsoft Outlook or third-party software, e.g. financial software or editorial systems, that the user already uses. While the tax consultant or legal consultant expresses matters in the word processing program, for example, or client e-mails are received in the mailbox of Microsoft Outlook, the computer-implemented method according to the invention, realized as software, semantically analyzes the content, searches the answer corpus and, in a display bar provided for the software, suggests suitable answer passages in the office application within a few seconds, said answer passages being able to be transferred directly into an answer to the client by the consultant (user) if appropriate.

The consultant (user) saves considerable time while researching and analyzing a legal matter and can use their working time productively. In addition, the consultant automatically always has all the technical information available in a version that is up to date with the software implementing the method.

1.-9. (canceled)

10. A computer-implemented method for determining relevant answer passages, from an answer corpus containing a plurality of answer passages indexed in a vector-free manner, concerning a query relating to a legal matter, the computer-implemented method comprising the following steps:
using a ranking function to assess the relevance of the plurality of answer passages of the answer corpus to the query and to determine a list containing the relevant answer passages, wherein the relevant answer passages are a fixed number of the plurality of answer passages of the answer corpus that are possible candidates for answering the query based on the ranking function,
sorting best candidates of the relevant answer passages within the list with descending relevance using at least one machine learning semantic language model, which embeds text passages context-sensitively in high-dimensional vector spaces in order to determine semantic similarities of the query and the relevant answer passages from the answer corpus, the query and the relevant answer passages determined using the ranking function being vectorized in real time by the at least one machine learning semantic language model only during the step of sorting after the relevant answer passages are determined using the ranking function, wherein the at least one machine learning semantic model is Sentence-BERT, which uses Siamese and triplet network structures to derive semantically meaningful sentence embeddings that can be compared using cosine similarities,
the at least one semantic language model being trained in a two-stage process before the step of sorting by:
a first pre-training step, the at least one machine learning semantic language model is trained on the basis of general texts and specialist legal texts in a general understanding of the language and taking into account specialist legal language, and
a second fine-tuning step, the at least one machine learning semantic language model uses training data containing questions and answers concerning legal matters to learn to calculate the relevance of possible answers concerning the questions in order to find relevant answer passages in the answer corpus,
and
outputting the best candidates of the relevant answer passages in the form of a list with the descending relevance.

11. The computer-implemented method as claimed in claim 10, wherein, in order to provide the answer corpus, legal documents are broken down into partial documents that each contain an answer passage of the plurality of answer passages, and the plurality of answer passages are indexed in a vector-free manner.

12. The computer-implemented method as claimed in claim 11, wherein the legal documents come from external databases.

13. The computer-implemented method as claimed in claim 11, wherein the external databases comprise software systems of the user of the method and also databases of third parties containing anonymized question-answer pairs.

14. A non-transitory computer-readable medium storing a computer program product comprising computer-executable commands that, when the program is executed by a computer, cause said computer to carry out the method steps as claimed in claim 10.

15. The non-transitory computer-readable medium storing the computer program product as claimed in claim 14, wherein the computer program product is part of a software application that a user uses to answer queries concerning legal matters.

16. The non-transitory computer-readable medium storing the computer program product as claimed in claim 15, wherein the computer program product is part of an office application.
